(19) United States
(12) Patent Application Publication
(10) Pub. No.: US 2026/0080249 A1
(43) Pub. Date: Mar. 19, 2026

(54) MULTI-HARDWARE ENERGY-CONSUMPTION-ORIENTED CHANNEL PRUNING METHOD AND RELATED PRODUCT

(71) Applicants: UNIVERSITY OF SCIENCE AND TECHNOLOGY OF CHINA, Hefei (CN); WUHU STATE-OWNED FACTORY OF MACHINING, Wuhu (CN)

(72) Inventors: Yi JIN, Hefei (CN); Haoxuan WANG, Hefei (CN); Huaian CHEN, Hefei (CN); Tao TU, Hefei (CN); Xin FAN, Hefei (CN); Yimeng SHAN, Hefei (CN)

(73) Assignees: UNIVERSITY OF SCIENCE AND TECHNOLOGY OF CHINA, Hefei (CN); WUHU STATE-OWNED FACTORY OF MACHINING, Wuhu (CN)

(21) Appl. No.: 19/401,201

(22) Filed: Nov. 25, 2025

Related U.S. Application Data
(63) Continuation-in-part of application No. PCT/CN2023/134605, filed on Nov. 28, 2023.

(51) Int. Cl. G06N 3/082; G06F 18/2113; G06N 3/0464; G06N 3/126

(52) U.S. Cl. CPC G06N 3/082; G06F 18/2113; G06N 3/0464; G06N 3/126; G06F 2219/10

(57) ABSTRACT

A multi-hardware energy-consumption-oriented channel pruning method and a related product. The method includes: ranking importance of a filter in a to-be-pruned convolutional neural network (CNN) model by using a feature distribution discrepancy (FDD) evaluation model based on a feature distribution of an original network model, and deleting a filter with a lowest importance ranking to generate a candidate first pruning model; determining an energy consumption of the candidate first pruning model by using an energy consumption estimation model based on actual measured data; performing trade-off processing on importance of a filter in the candidate first pruning model and the energy consumption of the candidate first pruning model by using a multi-objective evolutionary solving model, and obtaining a pruning scheme corresponding to each hardware device; and pruning the to-be-pruned CNN model by using the pruning scheme, and obtaining a second pruning model corresponding to each hardware device.

### CROSS REFERENCE TO RELATED APPLICATION

This patent application is a continuation-in-part of International Patent Application No. PCT/CN2023/134605, filed on Nov. 28, 2023.

### TECHNICAL FIELD

The present disclosure relates to the technical field of model compression, and in particular, to a multi-hardware energy-consumption-oriented channel pruning method and a related product.

### BACKGROUND

A convolutional neural network (CNN) is a feedforward neural network that incorporates convolution computation and possesses a deep structure, and is one of representative algorithms in deep learning. The CNN has demonstrated outstanding performance in various computer vision tasks. However, extensive computation and data movement of a CNN model lead to a high energy consumption, posing a challenge to deployment of the CNN model in an energy-constrained environment. Therefore, reducing an energy consumption of the CNN model is crucial for its deployment on a battery-powered edge device.

Among existing model compression technologies, structured pruning has gained increasing attention due to its easier deployment on general-purpose hardware. However, current hardware-oriented pruning methods generate only one energy-efficient CNN model for a specific energy budget of a single hardware device in a single pruning process. This results in low pruning efficiency.

Therefore, how to improve pruning efficiency has become an urgent issue that needs to be addressed by those skilled in the art.

### SUMMARY

In view of the above problems, the present disclosure provides a multi-hardware energy-consumption-oriented channel pruning method and a related product. A multi-objective evolutionary solving model is employed to provide pruning schemes for a plurality of hardware devices in a single pruning process, thereby solving a problem of low pruning efficiency in the prior art.

According to a first aspect, the present disclosure provides a multi-hardware energy-consumption-oriented channel pruning method, including:
ranking importance of a filter in a to-be-pruned CNN model by using a feature distribution discrepancy (FDD) evaluation model based on a feature distribution of an original network model, deleting a filter with a lowest importance ranking, and obtaining a candidate first pruning model;
determining an energy consumption of the candidate first pruning model by using an energy consumption estimation model based on actual measured data;
performing trade-off processing on importance of a filter in the candidate first pruning model and the energy consumption of the candidate first pruning model by using a multi-objective evolutionary solving model, and obtaining a low-energy-consumption pruning scheme corresponding to each hardware device; and
pruning the to-be-pruned CNN model by using the low-energy-consumption pruning scheme, and obtaining a second pruning model corresponding to each hardware device.

Optionally, the ranking importance of a filter in a to-be-pruned CNN model by using an FDD evaluation model based on a feature distribution of an original network model includes:
determining a feature distribution of each layer of the to-be-pruned CNN model based on image evaluation data;
performing discrepancy evaluation on the feature distribution based on the feature distribution and the FDD evaluation model, and obtaining a discrepancy evaluation result value;
and ranking importance of a filter corresponding to each feature map of the to-be-pruned CNN model based on the discrepancy evaluation result value.

Optionally, the determining an energy consumption of the candidate first pruning model by using an energy consumption estimation model based on actual measured data includes:
constructing a lookup table for each hardware device based on the actual measured data; and
determining the energy consumption of the candidate first pruning model by using the energy consumption estimation model based on the lookup table.

Optionally, the determining the energy consumption of the candidate first pruning model by using the energy consumption estimation model includes:
determining energy consumption values of all layers of the candidate first pruning model by using the energy consumption estimation model; and
summing the energy consumption values to determine the energy consumption of the candidate first pruning model.

Optionally, the performing trade-off processing on importance of a filter in the candidate first pruning model and the energy consumption of the candidate first pruning model by using a multi-objective evolutionary solving model, and obtaining a low-energy-consumption pruning scheme corresponding to each hardware device includes:
constructing the multi-objective evolutionary solving model based on the importance of the filter in the candidate first pruning model and the energy consumption of the candidate first pruning model;
solving the multi-objective evolutionary solving model by using a layer-wise pruning strategy, and exploring an energy-efficient pruning solution for each layer of the to-be-pruned CNN model; and determining, based on the energy-efficient pruning solution, the low-energy-consumption pruning scheme corresponding to each hardware device.

Optionally, the solving the multi-objective evolutionary solving model by using a layer-wise pruning strategy, and exploring an energy-efficient pruning solution for each layer of the to-be-pruned CNN model includes:
constructing a single-layer objective evolutionary solving model for each layer of the to-be-pruned CNN model based on the multi-objective evolutionary solving model; and
exploring the energy-efficient pruning solution for each layer of the to-be-pruned CNN model by using the single-layer objective evolutionary solving model.

Optionally, the multi-hardware energy-consumption-oriented channel pruning method further includes:
when a new hardware device is introduced, obtaining a hardware characteristic of the new hardware device;
identifying a hardware device whose hardware characteristic is most similar to the hardware characteristic of the new hardware device from an existing hardware device repository; and
using the hardware device whose hardware characteristic is most similar to the hardware characteristic of the new hardware device as a proxy, and determining a pruning scheme of the new hardware device.

According to a second aspect, the present disclosure provides a multi-hardware energy-consumption-oriented channel pruning apparatus, including:
a deletion module configured to rank importance of a filter in a to-be-pruned CNN model by using an FDD evaluation model based on a feature distribution of an original network model, delete a filter with a lowest importance ranking, and obtain a candidate first pruning model;
a determining module configured to determine an energy consumption of the candidate first pruning model by using an energy consumption estimation model based on actual measured data;
a processing module configured to perform trade-off processing on importance of a filter in the candidate first pruning model and the energy consumption of the candidate first pruning model by using a multi-objective evolutionary solving model, and obtain a low-energy-consumption pruning scheme corresponding to each hardware device; and a pruning module configured to prune the to-be-pruned CNN model by using the low-energy-consumption pruning scheme, and obtain a second pruning model corresponding to each hardware device.

According to a third aspect, the present disclosure provides a multi-hardware energy-consumption-oriented channel pruning device, including:
a memory configured to store a computer program; and
a processor configured to execute the computer program to perform steps of the multi-hardware energy-consumption-oriented channel pruning method according to any one of the above implementations.

According to a fourth aspect, the present disclosure provides a readable storage medium, where the readable storage medium stores a computer program, and the computer program is executed by a processor to perform steps of the multi-hardware energy-consumption-oriented channel pruning method according to any one of the above implementations.

It can be seen from the above technical solutions that compared with the prior art, the present disclosure has the following advantages:
The present disclosure first ranks importance of a filter in a to-be-pruned CNN model by using an FDD evaluation model based on a feature distribution of an original network model, deletes a filter with a lowest importance ranking, and obtains a candidate first pruning model. Then an energy consumption of the candidate first pruning model is determined by using an energy consumption estimation model based on actual measured data, trade-off processing is performed on importance of a filter in the candidate first pruning model and the energy consumption of the candidate first pruning model by using a multi-objective evolutionary solving model, and a low-energy-consumption pruning scheme corresponding to each hardware device is obtained. Finally, the to-be-pruned CNN model is pruned by using the low-energy-consumption pruning scheme, and a second pruning model corresponding to each hardware device is obtained. In this way, the multi-objective evolutionary solving model is employed to provide pruning schemes for a plurality of hardware devices in a single pruning process, thereby improving pruning efficiency of a CNN model.

### BRIEF DESCRIPTION OF THE DRAWINGS

+

FIG. 1 is a flowchart of a multi-hardware energy-consumption-oriented channel pruning method according to the present disclosure;

FIG. 2 is a schematic structural diagram of an all-in-one energy-consumption-oriented channel pruning framework according to the present disclosure;

FIG. 3 is a schematic diagram of a pruning result of Visual Geometry Group 16 (VGG-16) on a Canadian Institute for Advanced Research 10 (CIFAR-10) dataset according to the present disclosure;

FIG. 4 is a schematic diagram of a pruning result of residual network (ResNet)-56 on a CIFAR-10 dataset according to the present disclosure;

FIG. 5 is a schematic diagram of a pruning result of ResNet-50 on an ImageNet dataset according to the present disclosure;

FIG. 6 is a schematic diagram of a pruning result of MobileNet-V2 on an ImageNet dataset according to the present disclosure; and

FIG. 7 is a schematic structural diagram of a multi-hardware energy-consumption-oriented channel pruning apparatus according to the present disclosure.

### DETAILED DESCRIPTION OF THE EMBODIMENTS

As mentioned above, existing hardware-oriented pruning methods have a problem of low pruning efficiency. Specifically, compared with model-oriented pruning methods, the hardware-oriented pruning methods are more excellent in reducing an energy consumption. However, an increasing quantity of hardware devices and significantly different energy budgets of different devices pose new challenges for the existing hardware-oriented pruning methods. In a cross-platform dynamic deployment scenario, the existing hardware-oriented pruning methods can only generate one energy-efficient CNN model for a specific energy budget of one hardware device in a single pruning process. When addressing various requirements of a cross-platform dynamic deployment scenario involving numerous energy budgets and hundreds of different device types, a pruning cost of the existing hardware-oriented pruning methods increases linearly with quantities of energy budgets and hardware devices, and pruning efficiency also decreases accordingly.

To solve the above problem, the present disclosure provides a multi-hardware energy-consumption-oriented channel pruning method, including: first ranking importance of a filter in a to-be-pruned CNN model by using an FDD evaluation model based on a feature distribution of an original network model, deleting a filter with a lowest importance ranking, and obtaining a candidate first pruning model; then determining an energy consumption of the candidate first pruning model by using an energy consumption estimation model based on actual measured data, performing trade-off processing on importance of a filter in the candidate first pruning model and the energy consumption of the candidate first pruning model by using a multi-objective evolutionary solving model, and obtaining a low-energy-consumption pruning scheme corresponding to each hardware device; and finally pruning the to-be-pruned CNN model by using the low-energy-consumption pruning scheme, and obtaining a second pruning model corresponding to each hardware device.

In this way, the multi-objective evolutionary solving model is employed to provide pruning schemes for a plurality of hardware devices in a single pruning process, thereby improving pruning efficiency of a CNN model.

It should be noted that the multi-hardware energy-consumption-oriented channel pruning method and a related product provided in the present disclosure can be applied in the technical field of model compression. The above is only an example and does not limit application fields of the multi-hardware energy-consumption-oriented channel pruning method and the related product provided in the present disclosure.

In order to make the objectives, technical solutions, and advantages of the embodiments of the present disclosure clearer, the technical solutions in the embodiments of the present disclosure are clearly and completely described below with reference to the accompanying drawings in the embodiments of the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

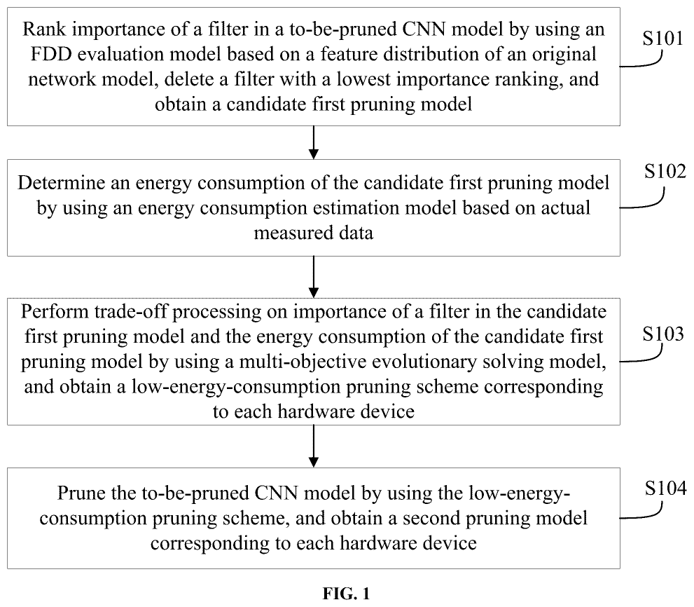

FIG. 1 is a flowchart of a multi-hardware energy-consumption-oriented channel pruning method according to the present disclosure. As shown in FIG. 1, the multi-hardware energy-consumption-oriented channel pruning method provided in the present disclosure may include the following steps:

S101: Rank importance of a filter in a to-be-pruned CNN model by using an FDD evaluation model based on a feature distribution of an original network model, delete a filter with a lowest importance ranking, and obtain a candidate first pruning model.

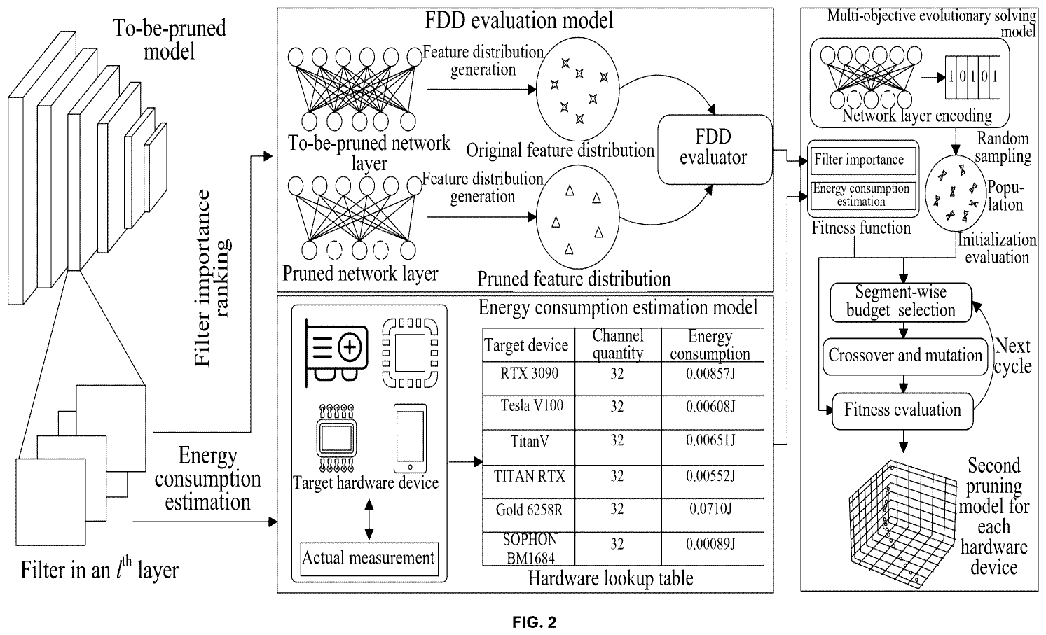

In practical applications, existing hardware-oriented pruning methods can only generate one energy-efficient CNN model for a specific energy budget of one hardware device in a single pruning process. When addressing various requirements of a cross-platform dynamic deployment scenario involving numerous energy budgets and hundreds of different device types, a pruning cost of the existing hardware-oriented pruning methods increases linearly with quantities of energy budgets and hardware devices, and pruning efficiency also decreases accordingly. Therefore, the present disclosure provides the multi-hardware energy-consumption-oriented channel pruning method. A multi-objective evolutionary solving model is employed to provide pruning schemes for a plurality of hardware devices in the single pruning process, thereby improving the pruning efficiency. FIG. 2 is a schematic structural diagram of an all-in-one energy-consumption-oriented channel pruning framework according to the present disclosure. As shown in FIG. 2, the present disclosure proposes an all-in-one energy consumption-oriented channel pruning framework (namely, an energy-aware pruning (AEP) framework) as a multi-hardware energy-consumption-oriented channel pruning apparatus to implement the multi-hardware energy-consumption-oriented channel pruning method proposed in the present disclosure. The AEP framework is composed of an FDD evaluator, an energy consumption estimator (ECE), and a multi-objective evolutionary solver (MOES). The FDD evaluator evaluates the importance of the filter from a perspective of a feature distribution, and then removes a filter that has a small impact on the feature distribution. For a multi-device cross-platform dynamic deployment scenario, the FDD evaluator uses the FDD evaluation model to evaluate the importance of the filter based on a small amount of evaluation data, that is, to confirm importance of each filter in a CNN for a feature distribution of a current layer. After a result is obtained, each filter is ranked in descending order of importance, and then the filter with the lowest importance ranking (namely, lowest importance) is removed to obtain the candidate first pruning model.

Furthermore, since there are different methods for ranking the importance of the filter in the to-be-pruned CNN model, the present disclosure can provide a description for one possible ranking method.

In a case, how to rank the importance of the filter in the to-be-pruned CNN model is described. Correspondingly, the step of ranking the importance of the filter in the to-be-pruned CNN model by using the FDD evaluation model based on the feature distribution of the original network model includes:
determining a feature distribution of each layer of the to-be-pruned CNN model based on image evaluation data;
performing discrepancy evaluation on the feature distribution based on the feature distribution of an original model and the FDD evaluation model, and obtaining a discrepancy evaluation result value; and ranking importance of a filter corresponding to each feature map of the to-be-pruned CNN model based on the discrepancy evaluation result value.

For the CNN, if a feature map has almost no impact on a feature distribution of a corresponding layer, importance of a filter corresponding to the feature map for a current hardware device can be considered low. Therefore, such a feature map rarely affecting a network capacity is deleted. Based on this idea, the feature distribution of each feature map in the to-be-pruned CNN model is first determined by the FDD evaluator in the AEP framework based on a small amount of image evaluation data. Then, based on the feature distribution, a discrepancy between the original feature distribution and a pruned feature distribution is measured, and the discrepancy evaluation result value is obtained. Specifically, it is set that m and n respectively represent the feature distribution and the pruned feature distribution. A definition of the FDD evaluation model in a data space Z is as follows:

$$ℱ𝒟𝒟 = {sup}_{f ∈ ℱ} ( {𝔼}_{x ∼ m} [ f ( x ) ] , {𝔼}_{y ∼ n} [ f ( y ) ] ) .$$

[symbol] represents a function class: ƒ:Z→R. It is set that F represents a unit ball in a universal Reproducing Kernel Hilbert Space (RKHS), which is represented by H. In the RKHS, ƒ(a) can be represented as follows: ƒ(a)= [symbol] ƒ,θ(a) [symbol] _{H}, where θ:Z→H represents a feature space mapping from Z to H. In addition, the FDD evaluator can be rewritten as follows:

$$ℱ𝒟𝒟 = {sup}_{\vert \vert f \vert {\vert}_{ℋ} \leq 1} ( {𝔼}_{x ∼ m} [ f ( x ) ] - {𝔼}_{y ∼ n} [ f ( y ) ] ) , ℱ𝒟𝒟 = {sup}_{\vert \vert f \vert {\vert}_{ℋ} \leq 1} {〈 {𝔼}_{x ∼ m} [ θ ( x ) ] - {𝔼}_{y ∼ n} [ θ ( y ) ] , f 〉}_{ℋ} , ℱ𝒟𝒟 = {‖ {𝔼}_{x ∼ m} [ θ ( x ) ] - {𝔼}_{y ∼ n} [ θ ( y ) ] ‖}_{ℋ} .$$

It is set that O={o¹, . . . o^{b}} and P={p¹, . . . p^{b}} respectively represent independent and identically distributed samples obtained from the feature distributions m and n. Herein, b represents a quantity of images used to evaluate the importance of the filter. oⁱ∈R^{C×R} and pⁱ∈R^{C×R}, where C and R respectively represent a quantity of output channels and a resolution of the feature map. An empirical estimate of the FDD evaluator can be expressed as follows:

$$ℱ𝒟𝒟 = {‖ \frac{1}{b} {{\sum }_{i = 1}}^{b} [ θ ( {o}^{i} ) ] - \frac{1}{b} {\sum }_{j = 1}^{b} [ θ ( {p}^{j} ) ] ‖}_{ℋ} ,$$

Then, a kernel trick is introduced, and the above formula can also be expressed as follows:

$$𝒟𝒟 = \frac{1}{b} {\sum }_{i = 1}^{b} ( {( \frac{1}{{R}^{2}} ( {\sum }_{u = 1}^{R} {\sum }_{z = 1}^{R} ( {x}^{i} + {y}^{j} - 2 {z}^{i} ) ) )}^{\frac{1}{2}} ) ,$$

In the above expression,

$${x}^{i} = k ( {o}_{. u}^{i} , {o}_{. z}^{i} ) , {y}^{i} = k ( {p}_{. u}^{i} , {p}_{. z}^{i} ) , and {z}^{i} = k ( {o}_{. u}^{i} , {p}_{. z}^{i} ) ,$$

where k(.,.) represents a kernel function, which is used to map a sample vector into a high-dimensional feature space.

$${o}_{. u}^{i} and {p}_{. u}^{i}$$

respectively represent u^{th} vectors of the oⁱ and the p. Then, a polynomial kernel function is used to project the sample vector to the high-dimensional feature space, which can be defined as k(x,y)=(x^{T}y+c)^{d}. In this way, if c=0 and d=2 are set empirically, a value of the FDD evaluator (namely, the discrepancy evaluation result value) can be obtained. It should be noted that the AEP framework ranks the importance of the filter based on the value of the FDD evaluator. A smaller value of the FDD evaluator corresponds to a higher importance of the filter.

S102: Determine an energy consumption of the candidate first pruning model by using an energy consumption estimation model based on actual measured data.

In practical applications, the ECE in the AEP framework evaluates the energy consumption of the candidate first pruning model on each to-be-deployed hardware device. Specifically, the ECE obtains actual measured data of each first pruning model, and then determines the energy consumption of the candidate first pruning model based on the energy consumption estimation model.

Furthermore, since there are different methods for determining the energy consumption of the candidate first pruning model by using the energy consumption estimation model based on the actual measured data, the present disclosure can provide a description for one possible determination method.

In a case, how to determine the energy consumption of the candidate first pruning model based on the actual measured data is described. Correspondingly, the S102 in which the energy consumption of the candidate first pruning model is determined by using the energy consumption estimation model based on the actual measured data may specifically include:
constructing a lookup table for each hardware device based on the actual measured data; and
determining the energy consumption of the candidate first pruning model by using the energy consumption estimation model based on the lookup table.

In practical applications, the ECE developed in the AEP framework can efficiently estimate an energy consumption of a CNN model by using a small amount of actual measured data. Unlike a previous method for designing a hardware-specific energy consumption model, the ECE eliminates a need for specialized hardware-related knowledge, thereby enhancing a capability of the AEP framework to be applied to various hardware devices. Specifically, the ECE first constructs the lookup table for each hardware device based on the actual measured data, and then uses the constructed lookup table to estimate the energy consumption of the candidate first pruning model based on the energy consumption estimation model.

Additionally, since there are different methods for determining the energy consumption of the candidate first pruning models, the present disclosure can provide a description for one possible determination method.

In a case, how to determine the energy consumption of the candidate first pruning model is described. Correspondingly, the determining the energy consumption of the candidate first pruning model by using the energy consumption estimation model includes:
determining energy consumption values of all layers of the candidate first pruning model by using the energy consumption estimation model; and
summing the energy consumption values to determine the energy consumption of the candidate first pruning model.

In practical applications, the energy consumption of the candidate first pruning model can be regarded as a sum of an energy consumption of each layer, which is shown as follows:

$$E ( {\hat{W}}_{r} ) = {\sum }_{i = 1}^{L} e ( {\hat{W}}_{r}^{{}_{i}} ) ,$$

Through an accumulation algorithm, the energy consumption values of all the layers in the candidate first pruning model are determined and summed, thereby determining the energy consumption of the candidate first pruning model. Herein, Ŵᵣ represents a pruned model weight, and

$$e ( {\hat{W}}_{r}^{{}_{i}} )$$

represents an energy consumption of the pruned weight. The energy consumption of the pruned weight can be evaluated by using an existing monitoring tool.

S103: Perform trade-off processing on importance of a filter in the candidate first pruning model and the energy consumption of the candidate first pruning model by using the multi-objective evolutionary solving model, and obtain a low-energy-consumption pruning scheme corresponding to each hardware device.

In practical applications, to simultaneously optimize energy consumptions of a plurality of hardware devices, a multi-hardware energy-oriented channel pruning problem is modeled as a multi-objective optimization problem, with a goal of finding a series of Pareto optimal solutions, namely, achieving an excellent trade-off between filter importance and an energy consumption on the hardware devices. Specifically, the MOES in the AEP framework is configured to quickly obtain a series of energy-efficient solutions for a plurality of energy budgets of the hardware devices, and the multi-objective evolutionary solving model is constructed as follows:

$${arg max}_{\hat{{W}_{r}}} \{ ( \hat{{W}_{r}} , 𝒳 ) , {λ}_{1} ( \hat{{W}_{r}} ) , … , {λ}_{m} ( \hat{{W}_{r}} ) \} ,$$

$${λ}_{i} ( \hat{{W}_{r}} ) = {E}_{i} ( W ) - {E}_{i} ( \hat{{W}_{r}} ) ,$$

By performing the trade-off processing on the importance of the filter in the candidate first pruning model and the energy consumption of the candidate first pruning model by using the multi-objective evolutionary solving model, a pruning scheme corresponding to each hardware device is obtained. In the above formula, L(⋅,⋅) represents a filter importance evaluation function, [symbol] ={x₁, x₂, . . . , x_{N}} represents a training image, N represents a quantity of training images, m represents a quantity of hardware devices,

$$\hat{{W}_{r}} = \{ {\hat{W}}_{r}^{{}_{1}} , {\hat{W}}_{r}^{{}_{2}} , {\hat{W}}_{r}^{{}_{3}} , … , {\hat{W}}_{r}^{{}_{L}} \} and W = \{ {W}^{1} , {W}^{2} , {W}^{3} , … , {W}^{L} \}$$

respectively represent the pruned weight and an original weight, and Eᵢ(W) and Eᵢ(Ŵᵣ) respectively represent energy consumptions of an original model and a pruned model of an i^{th} hardware device. In this way, based on the multi-objective evolutionary solving model, filter importance of the pruned model is maximized and an energy consumption of the pruned model is minimized across the hardware devices, such that an optimal pruning scheme corresponding to each hardware device is obtained.

Additionally, since there are different methods for obtaining the pruning scheme corresponding to each hardware device, the present disclosure can provide a description for one possible obtaining method.

In a case, how to obtain the low-energy-consumption pruning scheme corresponding to each hardware device is described. Correspondingly, the S103 in which the trade-off processing is performed on the importance of the filter in the candidate first pruning model and the energy consumption of the candidate first pruning model by using the multi-objective evolutionary solving model, and the low-energy-consumption pruning scheme corresponding to each hardware device is obtained may specifically include:
constructing the multi-objective evolutionary solving model based on the importance of the filter in the candidate first pruning model and the energy consumption of the candidate first pruning model;
solving the multi-objective evolutionary solving model by using a layer-wise pruning strategy, and exploring an energy-efficient pruning solution for each layer of the to-be-pruned CNN model; and
determining, based on the energy-efficient pruning solution, the low-energy-consumption pruning scheme corresponding to each hardware device.

In practical applications, the MOES in the AEP framework adopts the layer-wise pruning strategy to iteratively explore an energy-efficient pruning solution for each layer of the CNN model, thereby significantly improving efficiency of the multi-objective optimization problem. Specifically, for each hardware device, the MOES first extracts the importance of the filter in the candidate first pruning model and the energy consumption of the candidate first pruning model, and then constructs the multi-objective evolutionary solving model based on the importance of the filter and the energy consumption. The multi-objective evolutionary solving model is converted into an optimization model for each layer of the CNN by using the layer-wise pruning strategy, and the optimization model is solved, so as to explore the energy-efficient pruning solution for each layer of the to-be-pruned CNN model. Finally, the low-energy-consumption pruning scheme corresponding to each hardware device is determined based on the energy-efficient pruning solution.

Furthermore, since there are different methods for exploring the energy-efficient pruning solution for each layer of the to-be-pruned CNN model, the present disclosure can provide a description for one possible exploration method.

In a case, how to explore the energy-efficient pruning solution for each layer of the to-be-pruned CNN model is described. Correspondingly, the solving the multi-objective evolutionary solving model by using a layer-wise pruning strategy, and exploring an energy-efficient pruning solution for each layer of the to-be-pruned CNN model includes:
constructing a single-layer objective evolutionary solving model for each layer of the to-be-pruned CNN model based on the multi-objective evolutionary solving model; and
exploring the energy-efficient pruning solution for each layer of the to-be-pruned CNN model by using the single-layer objective evolutionary solving model.

In practical applications, no conflict is introduced in energy consumption across different hardware devices. When an energy consumption of the CNN model on one hardware device decreases, an energy consumption of the same model on another hardware device may also be reduced. Moreover, since an impact of deleting a filter mainly depends on its independence from other filters in a same layer, the layer-wise pruning strategy has almost no impact on performance of the pruned model and can greatly improve solving efficiency of the multi-objective evolutionary solving model. The present disclosure constructs a single-layer objective evolutionary solving model for each layer of the candidate first pruning model based on the multi-objective evolutionary solving model. For an i^{th} layer, a following model is available:

$${arg max}_{\hat{{W}_{r}}} \{ ( {\hat{W}}_{r}^{{}_{i}} , 𝒳 ) , {λ}_{1} ( {\hat{W}}_{r}^{{}_{i}} ) , … , {λ}_{m} ( {\hat{W}}_{r}^{{}_{i}} ) \} , {λ}_{j}^{i} ( {\hat{W}}_{r}^{{}_{i}} ) = {e}_{i} ( {W}^{i} ) - {e}_{j} ( {\hat{W}}_{r}^{{}_{i}} ) ,$$

Herein,

$${e}_{i} ( {W}^{i} ) and {e}_{j} ( {\hat{W}}_{r}^{{}_{i}} )$$

represent energy consumptions of an original weight and a pruned weight of the i^{th} layer on a j^{th} target hardware device. The single-layer objective evolutionary solving model is improved based on a multi-objective evolutionary algorithm (non-dominated sorting genetic algorithm III (NSGA-III)), and efficiently searches for the energy-efficient pruning solution for each layer of the to-be-pruned CNN model through a segment-wise budget selection strategy. Specifically, for a new individual Q and a parental individual P, the MOES evenly divides a combined individual set P∪Q into T segments based on energy consumptions of the individuals. For each segment, the MOES uses an elite selection strategy to select P/T most excellent individuals from all individuals in the segment to form a next generation. Finally, the MOES obtains a series of energy-efficient pruning solutions across a wide range of energy consumption levels.

S104: Prune the to-be-pruned CNN model by using the low-energy-consumption pruning scheme, and obtain a second pruning model corresponding to each hardware device.

In practical applications, after the trade-off processing, a pruning scheme for a to-be-pruned model corresponding to each hardware device is obtained. Each to-be-pruned model is then pruned using the pruning scheme corresponding to each hardware device, such that the second pruning model corresponding to each hardware device is obtained and deployed.

Furthermore, since there are different methods for obtaining a model pruning scheme of a new hardware device, the present disclosure can provide a description for one possible obtaining method.

In a case, how to obtain the model pruning scheme of the new hardware device is described. Correspondingly, the multi-hardware energy-consumption-oriented channel pruning method further includes:
when the new hardware device is introduced, obtaining a hardware characteristic of the new hardware device;
identifying a hardware device whose hardware characteristic is most similar to the hardware characteristic of the new hardware device from an existing hardware device repository; and
using the hardware device whose hardware characteristic is most similar to the hardware characteristic of the new hardware device as a proxy, and determining a pruning scheme of the new hardware device.

In practical applications, the AEP framework can simultaneously provide applicable energy-efficient pruning schemes for a plurality of different hardware devices, as well as a plurality of energy budgets for a single hardware device, thereby meeting diverse needs of the cross-platform dynamic deployment scenario. If the new hardware device is introduced after all existing hardware devices have been deployed, the AEP framework can analyze the hardware characteristic of the new hardware device, identifies a similar hardware device from the existing hardware device repository, and uses the similar hardware device as the proxy to determine an applicable pruning solution for the new hardware device. In this way, energy-efficient deployment is rapidly implemented for each hardware device.

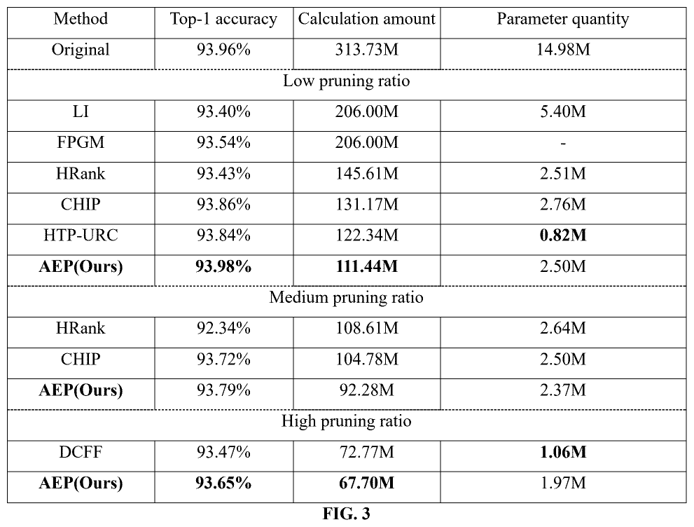

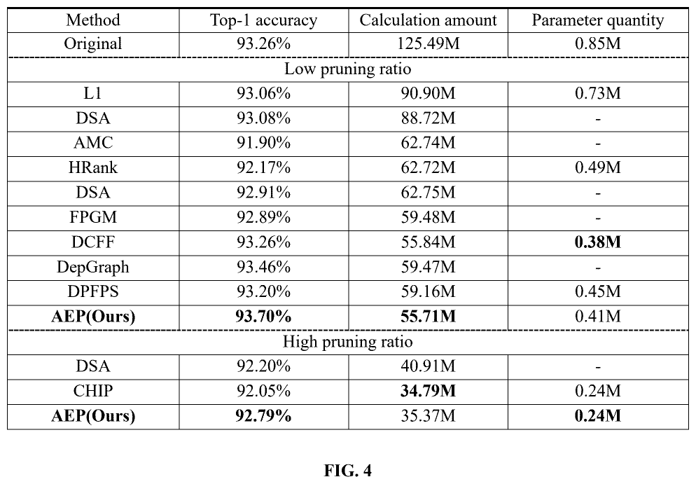

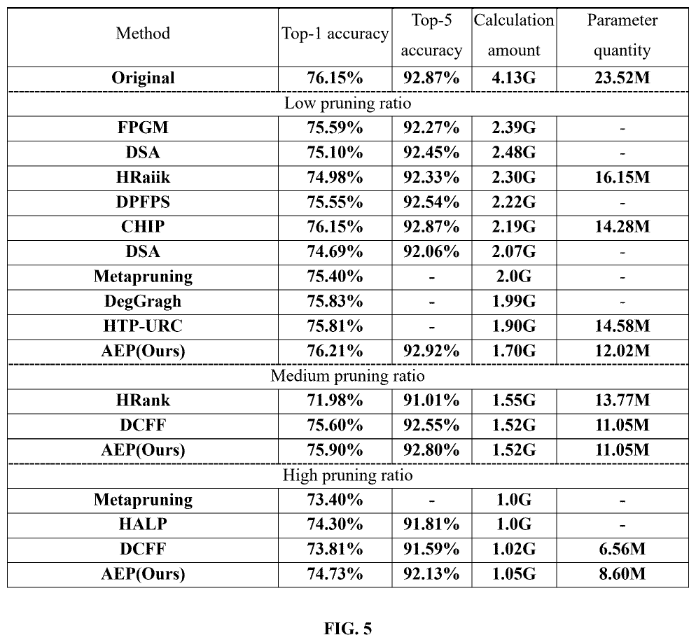

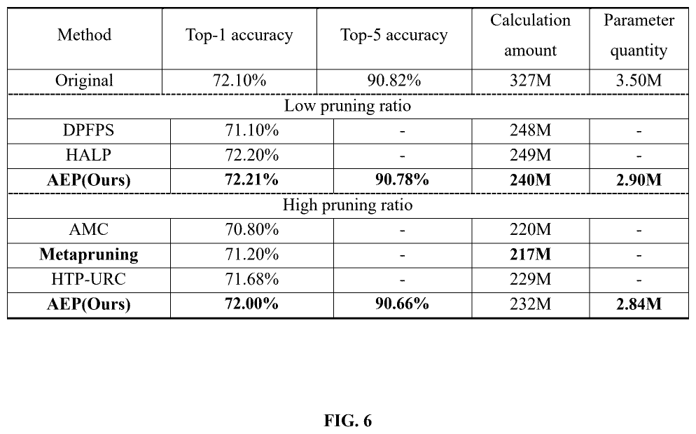

Additionally, comparative experiments are conducted to compare the AEP framework with various state-of-the-art (SOTA) pruning methods, including a model-oriented pruning method and a hardware-oriented pruning method. Specifically, classification performance is evaluated on CIFAR-10 and ImageNet datasets. Since previous methods mainly focus on reducing floating-point operations (FLOPs) and parameters, a quantity of FLOPs and a quantity of parameters are also used to evaluate performance of the pruning methods. Additionally, energy consumption evaluation is performed on six hardware devices. For fair comparison, for all other methods, their pruning models are recreated based on their official implementations, and their energy consumptions are then measured. FIG. 3 is a schematic diagram of a pruning result of VGG-16 on the CIFAR-10 dataset according to the present disclosure. FIG. 4 is a schematic diagram of a pruning result of ResNet-56 on the CIFAR-10 dataset according to the present disclosure. With reference to FIG. 3 and FIG. 4, the pruning results on the CIFAR-10 dataset are as follows: For the VGG-16, the AEP framework consistently outperforms the SOTA pruning methods under three different pruning ratios. For the ResNet-56, the AEP framework reduces the FLOPs by 55.61% and the parameters by 51.76%, and increases accuracy of the ResNet-56 by 0.44%. Additionally, the AEP framework outperforms others in terms of top-1 accuracy and a quantity of FLOPs under both low and high pruning ratios. FIG. 5 is a schematic diagram of a pruning result of ResNet-50 on the ImageNet dataset according to the present disclosure. FIG. 6 is a schematic diagram of a pruning result of MobileNet-V2 on the ImageNet dataset according to the present disclosure. As shown in FIG. 5 and FIG. 6, the pruning results on the ImageNet dataset are as follows: Compared with the original ResNet-50 model, the AEP framework reduces the FLOPs by 58.83% and the parameters by 48.89%, and increases the top-1 accuracy by 0.06%. Moreover, the AEP framework outperforms the SOTA pruning methods under three pruning ratios in terms of both the quantity of FLOPs and classification performance. The AEP framework reduces the FLOPs by 26.60% and improves the top-1 accuracy of the MobileNet-V2 by 0.11%. Additionally, the AEP framework achieves a better balance between the classification performance and the quantity of FLOPs under the low and high pruning ratios, outperforming the SOTA pruning methods. In particular, under the low pruning ratio, the AEP framework achieves higher accuracy compared with a hardware-aware latency pruning (HALP) method, which is a recent SOTA pruning method. Therefore, the AEP framework can efficiently compress a network architecture with depthwise separable convolution. Furthermore, for a plurality of energy budgets on a single hardware device, the AEP framework also achieves a better trade-off between accuracy and an energy consumption than the SOTA pruning methods, significantly reducing a pruning cost and thus facilitating efficient deployment of the CNN model in the cross-platform dynamic deployment scenario.

In conclusion, the present disclosure first ranks importance of a filter in a to-be-pruned CNN model by using an FDD evaluation model based on a small amount of image evaluation data, deletes a filter with a lowest importance ranking, and obtains a candidate first pruning model. Then an energy consumption of the candidate first pruning model is determined by using an energy consumption estimation model based on actual measured data, trade-off processing is performed on importance of a filter in the candidate first pruning model and the energy consumption of the candidate first pruning model by using a multi-objective evolutionary solving model, and a low-energy-consumption pruning scheme corresponding to each hardware device is obtained. Finally, the to-be-pruned CNN model is pruned by using the low-energy-consumption pruning scheme, and a second pruning model corresponding to each hardware device is obtained. In this way, the multi-objective evolutionary solving model is employed to provide pruning schemes for a plurality of hardware devices in a single pruning process, thereby improving pruning efficiency of a CNN model.

Based on the multi-hardware energy-consumption-oriented channel pruning method provided in the above embodiments, the present disclosure further provides a multi-hardware energy-consumption-oriented channel pruning apparatus. The multi-hardware energy-consumption-oriented channel pruning apparatus is described below with reference to embodiments and accompanying drawings.

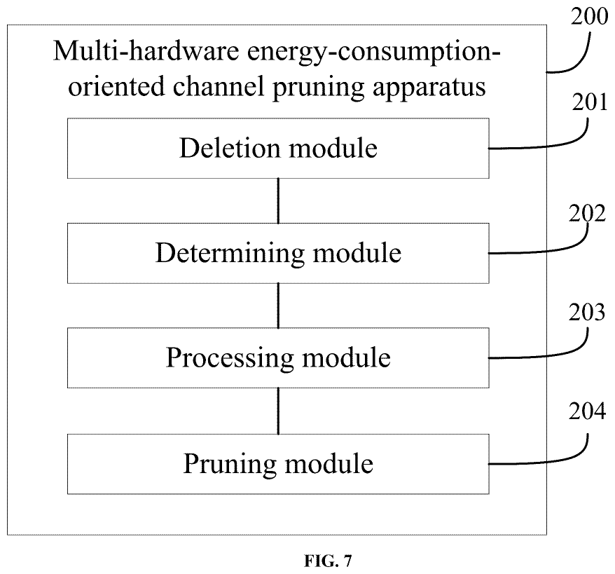

FIG. 7 is a schematic structural diagram of a multi-hardware energy-consumption-oriented channel pruning apparatus according to an embodiment of the present disclosure. As shown in FIG. 7, the multi-hardware energy-consumption-oriented channel pruning apparatus 200 provided in this embodiment of the present disclosure includes:

a deletion module 201 configured to rank importance of a filter in a to-be-pruned CNN model by using an FDD evaluation model based on a feature distribution of an original network model, delete a filter with a lowest importance ranking, and obtain a candidate first pruning model; a determining module 202 configured to determine an energy consumption of the candidate first pruning model by using an energy consumption estimation model based on actual measured data;

a processing module 203 configured to perform trade-off processing on importance of a filter in the candidate first pruning model and the energy consumption of the candidate first pruning model by using a multi-objective evolutionary solving model, and obtain a low-energy-consumption pruning scheme corresponding to each hardware device; and a pruning module 204 configured to prune the to-be-pruned CNN model by using the low-energy-consumption pruning scheme, and obtain a second pruning model corresponding to each hardware device.

As an implementation, regarding how to rank the importance of the filter in the to-be-pruned CNN model by using the FDD evaluation model, the deletion module 201 may be specifically configured to:
determine a feature distribution of each layer of the to-be-pruned CNN model based on image evaluation data;
perform discrepancy evaluation on the feature distribution based on the feature distribution and the FDD evaluation model, and obtain a discrepancy evaluation result value; and
rank importance of a filter corresponding to each feature map of the to-be-pruned CNN model based on the discrepancy evaluation result value.

As an implementation, regarding how to determine the energy consumption of the candidate first pruning model by using the energy consumption estimation model based on the actual measured data, the determining module 202 is specifically configured to:
construct a lookup table for each hardware device based on the actual measured data; and
determine the energy consumption of the candidate first pruning model by using the energy consumption estimation model based on the lookup table.

As an implementation, regarding how to determine the energy consumption of the candidate first pruning model by using the energy consumption estimation model, the determining module 202 may be specifically configured to:
determine energy consumption values of all layers of the candidate first pruning model by using the energy consumption estimation model; and
sum the energy consumption values to determine the energy consumption of the candidate first pruning model.

As an implementation, regarding how to perform the trade-off processing on the importance of the filter in the candidate first pruning model and the energy consumption of the candidate first pruning model by using the multi-objective evolutionary solving model, the processing module 203 includes a construction module, an exploration module, and a determining submodule.

The construction module is configured to construct the multi-objective evolutionary solving model based on the importance of the filter in the candidate first pruning model and the energy consumption of the candidate first pruning model.

The exploration module is configured to solve the multi-objective evolutionary solving model by using a layer-wise pruning strategy, and explore an energy-efficient pruning solution for each layer of the to-be-pruned CNN model.

The determining submodule is configured to determine, based on the energy-efficient pruning solution, the low-energy-consumption pruning scheme corresponding to each hardware device.

As an implementation, regarding how to explore the energy-efficient pruning solution for each layer of the to-be-pruned CNN model, the exploration module is specifically configured to:
construct a single-layer objective evolutionary solving model for each layer of the to-be-pruned CNN model based on the multi-objective evolutionary solving model; and
explore the energy-efficient pruning solution for each layer of the to-be-pruned CNN model by using the single-layer objective evolutionary solving model.

As an implementation, regarding model deployment for a new hardware device, the multi-hardware energy-consumption-oriented channel pruning apparatus 200 further includes a deployment module.

The deployment module is configured to: when the new hardware device is introduced, obtain a hardware characteristic of the new hardware device;
identify a hardware device whose hardware characteristic is most similar to the hardware characteristic of the new hardware device from an existing hardware device repository; and
use the hardware device whose hardware characteristic is most similar to the hardware characteristic of the new hardware device as a proxy, and determine a pruning scheme of the new hardware device.

In conclusion, the present disclosure first ranks importance of a filter in a to-be-pruned CNN model by using an FDD evaluation model based on a small amount of image evaluation data, deletes a filter with a lowest importance ranking, and obtains a candidate first pruning model. Then an energy consumption of the candidate first pruning model is determined by using an energy consumption estimation model based on actual measured data, trade-off processing is performed on importance of a filter in the candidate first pruning model and the energy consumption of the candidate first pruning model by using a multi-objective evolutionary solving model, and a low-energy-consumption pruning scheme corresponding to each hardware device is obtained. Finally, the to-be-pruned CNN model is pruned by using the low-energy-consumption pruning scheme, and a second pruning model corresponding to each hardware device is obtained. In this way, the multi-objective evolutionary solving model is employed to provide pruning schemes for a plurality of hardware devices in a single pruning process, thereby improving pruning efficiency of a CNN model.

Additionally, the present disclosure further provides a multi-hardware energy-consumption-oriented channel pruning device, including: a memory configured to store a computer program; and a processor configured to execute the computer program to perform steps of the multi-hardware energy-consumption-oriented channel pruning method according to any one of the above embodiments.

Additionally, the present disclosure further provides a readable storage medium. The readable storage medium stores a computer program. The computer program is executed by a processor to perform steps of the multi-hardware energy-consumption-oriented channel pruning method according to any one of the above embodiments.

The above description of the disclosed embodiments can enable a person skilled in the art to implement or practice the present disclosure. Various modifications to the embodiments are readily apparent to a person skilled in the art, and the generic principles defined herein may be practiced in other embodiments without departing from the spirit or scope of the present disclosure. Thus, the present disclosure is not limited to the embodiments shown herein but falls within the widest scope consistent with the principles and novel features disclosed herein.

What is claimed is:

1. A multi-hardware energy-consumption-oriented channel pruning method, comprising:
ranking importance of a filter in a to-be-pruned convolutional neural network (CNN) model by using a feature distribution discrepancy (FDD) evaluation model based on a feature distribution of an original network model, deleting a filter with a lowest importance ranking, and obtaining a candidate first pruning model;
determining an energy consumption of the candidate first pruning model by using an energy consumption estimation model based on actual measured data;
performing trade-off processing on importance of a filter in the candidate first pruning model and the energy consumption of the candidate first pruning model by using a multi-objective evolutionary solving model, and obtaining a low-energy-consumption pruning scheme corresponding to each hardware device; and
pruning the to-be-pruned CNN model by using the low-energy-consumption pruning scheme, and obtaining a second pruning model corresponding to each hardware device.

2. The multi-hardware energy-consumption-oriented channel pruning method according to claim 1, wherein the ranking importance of a filter in a to-be-pruned CNN model by using an FDD evaluation model based on a feature distribution of an original network model comprises:
determining a feature distribution of each layer of the to-be-pruned CNN model based on image evaluation data;
performing discrepancy evaluation on the feature distribution based on the feature distribution and the FDD evaluation model, and obtaining a discrepancy evaluation result value; and
ranking importance of a filter corresponding to each feature map of the to-be-pruned CNN model based on the discrepancy evaluation result value.

3. The multi-hardware energy-consumption-oriented channel pruning method according to claim 1, wherein the determining an energy consumption of the candidate first pruning model by using an energy consumption estimation model based on actual measured data comprises:
constructing a lookup table for each hardware device based on the actual measured data; and
determining the energy consumption of the candidate first pruning model by using the energy consumption estimation model based on the lookup table.

4. The multi-hardware energy-consumption-oriented channel pruning method according to claim 3, wherein the determining the energy consumption of the candidate first pruning model by using the energy consumption estimation model comprises:
determining energy consumption values of all layers of the candidate first pruning model by using the energy consumption estimation model; and
summing the energy consumption values to determine the energy consumption of the candidate first pruning model.

5. The multi-hardware energy-consumption-oriented channel pruning method according to claim 1, wherein the performing trade-off processing on importance of a filter in the candidate first pruning model and the energy consumption of the candidate first pruning model by using a multi-objective evolutionary solving model, and obtaining a low-energy-consumption pruning scheme corresponding to each hardware device comprises:
constructing the multi-objective evolutionary solving model based on the importance of the filter in the candidate first pruning model and the energy consumption of the candidate first pruning model;
solving the multi-objective evolutionary solving model by using a layer-wise pruning strategy, and exploring an energy-efficient pruning solution for each layer of the to-be-pruned CNN model; and
determining, based on the energy-efficient pruning solution, the low-energy-consumption pruning scheme corresponding to each hardware device.

6. The multi-hardware energy-consumption-oriented channel pruning method according to claim 5, wherein the solving the multi-objective evolutionary solving model by using a layer-wise pruning strategy, and exploring an energy-efficient pruning solution for each layer of the to-be-pruned CNN model comprises:
constructing a single-layer objective evolutionary solving model for each layer of the to-be-pruned CNN model based on the multi-objective evolutionary solving model; and
exploring the energy-efficient pruning solution for each layer of the to-be-pruned CNN model by using the single-layer objective evolutionary solving model.

7. The multi-hardware energy-consumption-oriented channel pruning method according to claim 1, further comprising:
when a new hardware device is introduced, obtaining a hardware characteristic of the new hardware device;
identifying a hardware device whose hardware characteristic is most similar to the hardware characteristic of the new hardware device from an existing hardware device repository; and
using the hardware device whose hardware characteristic is most similar to the hardware characteristic of the new hardware device as a proxy, and determining a pruning scheme of the new hardware device.

8. A multi-hardware energy-consumption-oriented channel pruning apparatus, comprising:
a deletion module configured to rank importance of a filter in a to-be-pruned CNN model by using an FDD evaluation model based on a feature distribution of an original network model, delete a filter with a lowest importance ranking, and obtain a candidate first pruning model;
a determining module configured to determine an energy consumption of the candidate first pruning model by using an energy consumption estimation model based on actual measured data;
a processing module configured to perform trade-off processing on importance of a filter in the candidate first pruning model and the energy consumption of the candidate first pruning model by using a multi-objective evolutionary solving model, and obtain a low-energy-consumption pruning scheme corresponding to each hardware device; and
a pruning module configured to prune the to-be-pruned CNN model by using the low-energy-consumption pruning scheme, and obtain a second pruning model corresponding to each hardware device.

9. A multi-hardware energy-consumption-oriented channel pruning device, comprising:
a memory configured to store a computer program; and
a processor configured to execute the computer program to perform steps of the multi-hardware energy-consumption-oriented channel pruning method according to claim 1.

10. A non-transitory readable storage medium, wherein the readable storage medium stores a computer program, and the computer program is executed by a processor to perform steps of the multi-hardware energy-consumption-oriented channel pruning method according to claim 1.

11. The multi-hardware energy-consumption-oriented channel pruning device according to claim 9, wherein the ranking importance of a filter in a to-be-pruned CNN model by using an FDD evaluation model based on a feature distribution of an original network model comprises:
determining a feature distribution of each layer of the to-be-pruned CNN model based on image evaluation data;
performing discrepancy evaluation on the feature distribution based on the feature distribution and the FDD evaluation model, and obtaining a discrepancy evaluation result value; and
ranking importance of a filter corresponding to each feature map of the to-be-pruned CNN model based on the discrepancy evaluation result value.

12. The multi-hardware energy-consumption-oriented channel pruning device according to claim 9, wherein the determining an energy consumption of the candidate first pruning model by using an energy consumption estimation model based on actual measured data comprises:
constructing a lookup table for each hardware device based on the actual measured data; and
determining the energy consumption of the candidate first pruning model by using the energy consumption estimation model based on the lookup table.

13. The multi-hardware energy-consumption-oriented channel pruning device according to claim 12, wherein the determining the energy consumption of the candidate first pruning model by using the energy consumption estimation model comprises:
determining energy consumption values of all layers of the candidate first pruning model by using the energy consumption estimation model; and
summing the energy consumption values to determine the energy consumption of the candidate first pruning model.

14. The multi-hardware energy-consumption-oriented channel pruning device according to claim 9, wherein the performing trade-off processing on importance of a filter in the candidate first pruning model and the energy consumption of the candidate first pruning model by using a multi-objective evolutionary solving model, and obtaining a low-energy-consumption pruning scheme corresponding to each hardware device comprises:
constructing the multi-objective evolutionary solving model based on the importance of the filter in the candidate first pruning model and the energy consumption of the candidate first pruning model;
solving the multi-objective evolutionary solving model by using a layer-wise pruning strategy, and exploring an energy-efficient pruning solution for each layer of the to-be-pruned CNN model; and
determining, based on the energy-efficient pruning solution, the low-energy-consumption pruning scheme corresponding to each hardware device.

15. The multi-hardware energy-consumption-oriented channel pruning device according to claim 14, wherein the solving the multi-objective evolutionary solving model by using a layer-wise pruning strategy, and exploring an energy-efficient pruning solution for each layer of the to-be-pruned CNN model comprises:
constructing a single-layer objective evolutionary solving model for each layer of the to-be-pruned CNN model based on the multi-objective evolutionary solving model; and
exploring the energy-efficient pruning solution for each layer of the to-be-pruned CNN model by using the single-layer objective evolutionary solving model.

16. The multi-hardware energy-consumption-oriented channel pruning device according to claim 9, further comprising:
when a new hardware device is introduced, obtaining a hardware characteristic of the new hardware device;
identifying a hardware device whose hardware characteristic is most similar to the hardware characteristic of the new hardware device from an existing hardware device repository; and
using the hardware device whose hardware characteristic is most similar to the hardware characteristic of the new hardware device as a proxy, and determining a pruning scheme of the new hardware device.

17. The non-transitory readable storage medium according to claim 10, wherein the ranking importance of a filter in a to-be-pruned CNN model by using an FDD evaluation model based on a feature distribution of an original network model comprises:
determining a feature distribution of each layer of the to-be-pruned CNN model based on image evaluation data;
performing discrepancy evaluation on the feature distribution based on the feature distribution and the FDD evaluation model, and obtaining a discrepancy evaluation result value; and
ranking importance of a filter corresponding to each feature map of the to-be-pruned CNN model based on the discrepancy evaluation result value.

18. The non-transitory readable storage medium according to claim 10, wherein the determining an energy consumption of the candidate first pruning model by using an energy consumption estimation model based on actual measured data comprises:
constructing a lookup table for each hardware device based on the actual measured data; and
determining the energy consumption of the candidate first pruning model by using the energy consumption estimation model based on the lookup table.

19. The non-transitory readable storage medium according to claim 18, wherein the determining the energy consumption of the candidate first pruning model by using the energy consumption estimation model comprises:
determining energy consumption values of all layers of the candidate first pruning model by using the energy consumption estimation model; and
summing the energy consumption values to determine the energy consumption of the candidate first pruning model.

20. The non-transitory readable storage medium according to claim 10, wherein the performing trade-off processing on importance of a filter in the candidate first pruning model and the energy consumption of the candidate first pruning model by using a multi-objective evolutionary solving model, and obtaining a low-energy-consumption pruning scheme corresponding to each hardware device comprises:
constructing the multi-objective evolutionary solving model based on the importance of the filter in the candidate first pruning model and the energy consumption of the candidate first pruning model;
solving the multi-objective evolutionary solving model by using a layer-wise pruning strategy, and exploring an energy-efficient pruning solution for each layer of the to-be-pruned CNN model; and
determining, based on the energy-efficient pruning solution, the low-energy-consumption pruning scheme corresponding to each hardware device.
